(19) United States
(12) Patent Application Publication
(10) Pub. No.: US 2008/0270228 A1
(43) Pub. Date: Oct. 30, 2008

(54) SYSTEM FOR DISPLAYING ADVERTISEMENTS ASSOCIATED WITH SEARCH RESULTS

(75) Inventor: Ali Dasdan, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/739,242

(22) Filed: Apr. 24, 2007

(51) Int. Cl. G06Q 30/00

(52) U.S. Cl. 705/14

(57) ABSTRACT

A system and method are disclosed for displaying information associated with a search result. The information may be an advertisement that is displayed when an associated search result is displayed as a result of a search query. For example, an advertiser may identify at least one search result to be associated with its advertisement, such that the advertisement is displayed on a search result page when the identified search result is one of the search results on the page.

### BACKGROUND

Online advertising may be an important source of revenue for enterprises engaged in electronic commerce. A number of different kinds of page-based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a page to be configured to contain advertisements. Online advertising may include sponsored searching, which includes advertisements related to a search query. Sponsored searching may require advertisers to bid for search keywords. It may be difficult for an advertiser to identify which keywords are most relevant to its advertisements. Accordingly, search advertising may be more effective if more options are available for providing advertisements.

### BRIEF DESCRIPTION OF THE DRAWINGS

The system and/or method may be better understood with reference to the following drawings and description. Non-limiting and non-exhaustive embodiments are described with reference to the following drawings. The components in the figures are not necessarily to scale, emphasis instead being placed upon illustrating the principles of the invention. In the figures, like referenced numerals designate corresponding parts throughout the different views.

FIG. 1 provides a simplified view of one embodiment of an operating environment;

FIG. 2 is a block diagram of an exemplary search system;

FIG. 3 is a flowchart depicting an embodiment for providing online advertising;

FIG. 4 is a flowchart depicting an embodiment for providing online advertising;

FIG. 5 is a diagram showing an embodiment for bidding options;

FIG. 6 is a diagram showing an embodiment for advertisement display options;

FIG. 7 is an illustration of one embodiment of a display of search results including an advertisement associated with the search results;

FIG. 8 is an illustration of one embodiment of a display of search results including an advertisement associated with the search results;

FIG. 9 is an illustration of one embodiment of a display of search results including an advertisement associated with the search results;

FIG. 10 is an illustration of one embodiment of a display of search results including an advertisement associated with the search results;

FIG. 11 is an illustration of one embodiment of a display of search results including an advertisement associated with the search results;

FIG. 12 is an illustration of one embodiment of a display of search results including an advertisement associated with the search results; and

FIG. 13 is an illustration a general computer system.

### DETAILED DESCRIPTION

By way of introduction, the embodiments described below include a system and method for providing online advertising. In particular, the embodiments relate to the display of advertisements that are targeted to the results of a search query. Advertisements may be associated with an item that appears as a search result, such that when the search result appears, then the advertisement also appears. As described herein search result or search result page may include any output that is displayed in response to a search query. The output may include any features or items on a search result page, but for simplicity, may be referred to throughout as search results.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments.

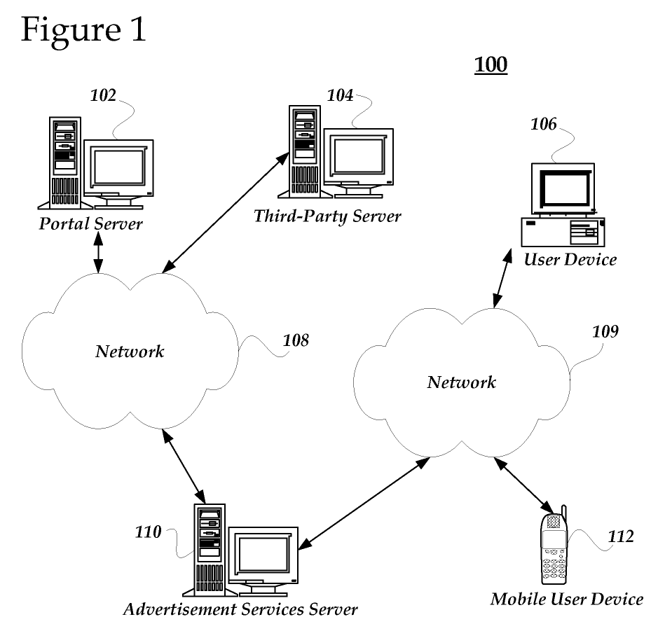

FIG. 1 provides a simplified view of one embodiment of a network environment 100 in which the present invention may be implemented. Not all of the depicted components may be required, however, and some embodiments of the invention may include additional components not shown in the figure. Variations in the arrangement and type of the components may be made without departing from the spirit or scope of the claims as set forth herein. Additional, different or fewer components may be provided.

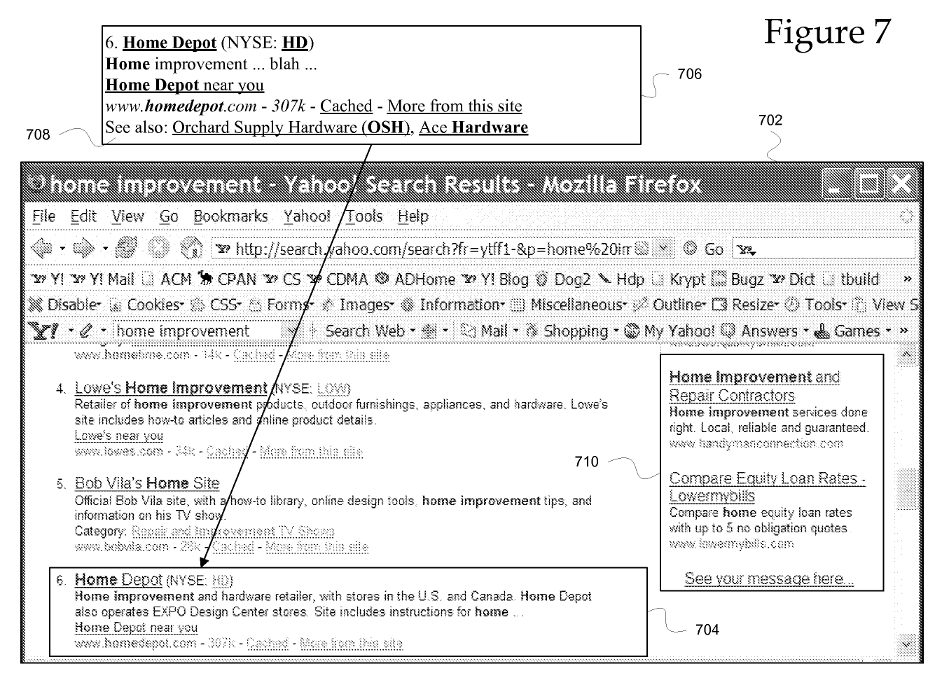

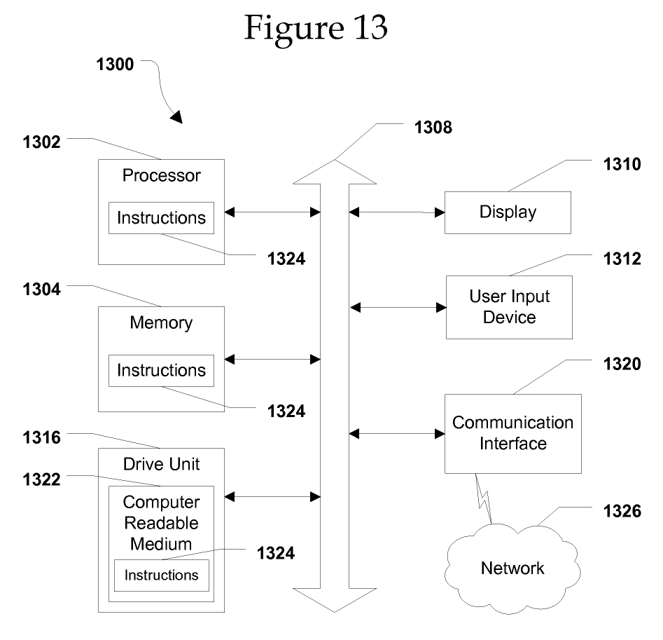

The network environment 100 includes an advertisement services server 110, which may provide a platform for selection, optimization, and/or distribution of advertisements for inclusion in pages, such as web pages (e.g. FIGS. 7-12). Pages may be provided to users by a portal server 102 and/or a third-party server 104. In FIG. 1, users are represented by a user device 106, depicted as a conventional personal computer, and/or other devices such as a mobile user device 112. The user devices 106 and 112 may include a network-enabled mobile phone, personal digital assistant (PDA), pager, network-enabled television, digital video recorder, such as TIVO®, and/or automobile. The user devices 106 and 112 may be the user device described below with respect to FIG. 13.

Some or all of advertisement services server 110, portal server 102, and/or third-party server 104 may be in communication with each other by way of network 108 and may include the system or components described below with respect to FIG. 13. The advertisement services server 110 and portal server 102 may each represent multiple linked computing devices, and multiple third-party servers, such as third-party server 104, may be included in the network environment 100. The network 108 may include a public or private network connection, such as a virtual private network or an encryption or other security mechanism employed over the public Internet, or the like.

The user device 106 and the mobile user device 112 are represented by user-interactive devices that typically run browser applications, and the like, to display requested pages received over a network. The user may be a consumer of goods or services who is searching for a business that is associated with the advertiser. Such devices are in communication with the portal server 102 and/or the third-party server 104 by way of the network 109.

The portal server 102, the third-party server 104, the advertisement services server 110, the user device 106, and/or the mobile user device 112 may represent computing devices of various kinds. Such computing devices may generally include any device that is configured to perform computation and that is capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the user device 106 may be configured to execute a browser application that employs HTTP to request information, such as a web page, from a web server, which may be a process executing on the portal server 102 or the third-party server 104.

The networks 108, 109 may be configured to couple one computing device to another computing device to enable communication of data between the devices. Networks 108, 109 may generally be enabled to employ any form of machine-readable media for communicating information from one device to another. Each of networks 108, 109 may include one or more of a wireless network, a wired network, a local area network (LAN), a wide area network (WAN), a direct connection such as through a Universal Serial Bus (USB) port, and the like, and may include the set of interconnected networks that make up the Internet. The networks 108, 109 may include any communication method by which information may travel between computing devices. The advertisement services server 110 may be used for providing advertisements that are displayed to user device 106. The network 109 may include all or part of the network 108 and the network 108 may include all or part of the network 109. The networks 108 and/or 109 may be the network discussed below with respect to FIG. 13.

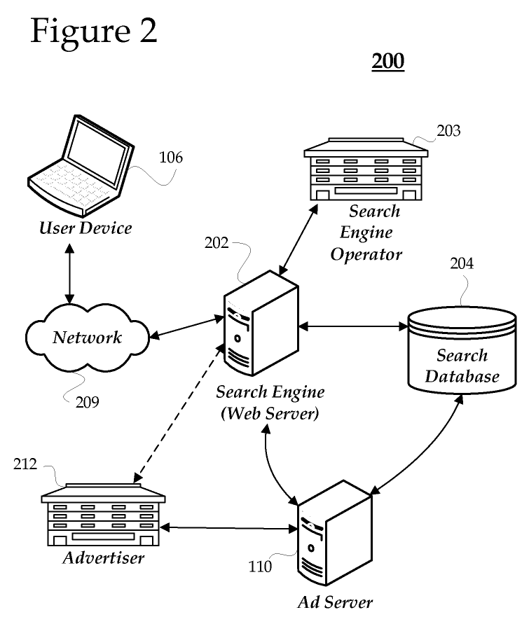

FIG. 2 is a block diagram of one embodiment of an exemplary search system 200. In search system 200, a user device 106 is coupled with a search engine 202 through a network 209. The search engine 202 is coupled with a search database 204, and both are coupled with an ad server 110. The search database 204 may contain one or more databases for each subsystem within the search engine 202. Some subsystems include the crawling subsystem that crawls the web and downloads it into a content database, the web graph subsystem that constructs a graph database out of the content database, and the indexer subsystem that creates an index database to help find content for input search queries. A search engine operator 203 may be coupled with the search engine 202, and an advertiser 212 may be coupled with the ad server 110 and/or the search engine 202. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 106 may be a computing device for a user to connect to a network 209, such as the Internet. Examples of a user device include but are not limited to a personal computer, personal digital assistant (“PDA”), cellular phone, or other electronic device. The user device 106 may be configured to access web pages or other data/information over the network 209 with a web browser, such as INTERNET EXPLORER® (sold by Microsoft Corp., Redmond, Wash.). The user device 106 may be a computer enabling a user to view web pages over the network 109, such as the Internet. In one embodiment, a user views the web browser containing data from the Internet. The data displayed on the browser may include advertisements. In an alternative embodiment, other software programs may also display advertisements received over the network 209 or from a different source.

In one embodiment, the search engine 202 provides an interface or a web page, such as the web page which may be accessed on the World Wide Web at yahoo.com (operated by Yahoo! Inc., in Sunnyvale, Calif.), which is used to search for pages in a network, such as the network 209. The search engine 202 may be operated by a search engine operator 203 that maintains and oversees the operation of the search engine 202. The user may input a search query (also referred to as a term or a keyword) into the user device 106 that is transmitted to the search engine 202. A single search query may include multiple words or phrases. The search engine 202 performs a search for the search query and provides the results of the search for display on the user device 106. The search engine 202 may also display advertisements that are relevant to the search results and provided by the ad server 110 as discussed below.

The search engine 202 may include or be coupled with a search database 204. The search database 204 may receive data from internal sources such as the subsystems of the search engine 202 or other systems within the search engine operator 203. The search database 204 may also receive data from external sources. An external data source may include search results from other search engines or other sources. For example, a search engine, other than search engine 202, may be an external data source and provide data to the search database 204. Other data may include other searching or web browsing tendencies identified by the search engine 202 that is relevant to the search query data.

An ad server 110 may be coupled with the search engine 202 and is configured to provide advertisements to be displayed on the user device 106 with the search results. In one embodiment, an advertiser 212 pays a fee for particular keywords and whenever a user searches with that keyword, the advertiser's advertisement is displayed with the search results. The advertiser 212 may also be referred to as an information provider that not only provides advertisements, but also conveys other information, such as text, graphics, icons, or images. The advertiser 212 may be coupled with the search engine 202 and/or the ad server 110 for providing its advertisements for display. In one embodiment, the ad server 110 is coupled with a plurality of advertisers from which it receives advertisements as well as a price, bid, or fee for the advertisement. The price, bid, or fee may be used in selecting the advertisement(s) provided to the search engine 202. The price, bid, or fee may be referred as a purchase throughout the present disclosure.

The cost for any given keyword may be based upon its popularity with users. Accordingly, as the popularity of a keyword increases, so does the cost to advertisers to purchase ad space associated with that keyword. Conversely, in some circumstances the rarer the word is, then the higher its cost. Alternatively, advertisements associated with a keyword may be the result of a bidding system in which a bid based on the overall quality of the advertisements is established. The quality may in turn depend on the number of impressions or clicks that the advertisement is expected to get. As discussed below, the advertisement may be associated with the output from the search engine 202, such as the search results. Accordingly, when that output is displayed on the user device 106, the associated advertisement is displayed. The ad server 110 may include a database of available advertisements that are chosen by the ad server 110 and/or the search engine 202 for display on the user device 106. The available advertisements may be received from advertisers, such as advertiser 212. In particular, the advertisements may be associated with a particular search result, such that the advertisement may be displayed when the particular search result is displayed as determined by the search engine 202 and/or ad server 110.

In one embodiment, when a user performs a search on user device 106, the search is submitted to the search engine 202 over the network 209. The search request is recorded in the search database 204. The results of the search are determined by the search engine 202, and the ad server provides the relevant advertisement for the particular search, which is chosen from available advertisements that may be relevant to the particular search. The search results including the advertisements may be displayed on the user device 106.

Any of the components in system 200 may be coupled with one another through a network. For example, the ad server 110 may be coupled with the search engine 202, or the search database 204 over a network. Likewise, the advertiser 212 may be coupled with the search engine 202 and/or the ad server 110 over a network. Accordingly, any of the components in system 200 may include communication ports configured to connect with a network. The present disclosure contemplates a computer-readable medium that includes instructions or receives and executes instructions responsive to a propagated signal, so that any device connected to a network can communicate voice, video, audio, images or any other data over a network.

The network or networks that may connect any of the components in system 200 may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols.

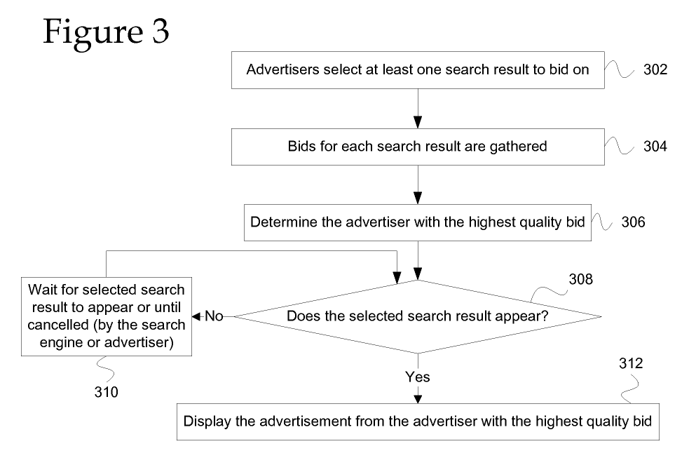

FIG. 3 is a flowchart depicting an embodiment of online advertising according to the present invention. FIG. 3 relates to the purchasing or bidding of advertisements by an advertiser. The advertisements are displayed based at least in part on the search results from a search query. In one embodiment, advertisers, such as the advertiser 212, provide advertisements that are associated with a particular search result. A bidding process may be used, such that multiple advertisers place a bid for a search result. The bid may be the price that an advertiser pays to the search engine each time its advertisement is clicked on. Alternatively, the bid may be a fixed price that an advertiser pays to have its advertisement displayed. An advertisement location may be sold for a fixed price or may be filled based on the advertiser who offers the best bid.

As described below, the bidding may be on the output of the search engine 202. Rather than purchasing or bidding on a search keyword, which is an input to the search engine 202, the user may purchase or bid on at least one output from the search engine 202. In one embodiment, the output from the search engine 202 is a search result. In block 302, an advertiser 212 selects at least one search result to bid on or purchase. The output from a search engine may include any content, text, media, or information. In one example, a search engine 202 provides a listing of search results that include links or URL's to other web pages. Alternatively, the search results may include any listing of data. For example, a search for media may include a listing of music songs or files for download, which are the search results. A search for images may include a listing of images. For example, if a user performs an image search for Cubs, the Chicago Cubs® may purchase advertising space based on the search results for display of a Chicago Cubs® image. In addition, the advertisements that may be displayed may include a link that is associated with a search result, such as a link as in FIG. 7-12, which are discussed below.

Accordingly, advertisers may pay the search engine operator for advertisements to be associated with at least one search result, regardless of its form. The association of an advertisement with a search result may include the display of that advertisement whenever the search result is displayed. The advertisement may be displayed at any location, including but not limited to being displayed adjacent the search result.

FIG. 7 is an illustration of one embodiment of providing an online advertisement based on search results. Search results may be displayed on a page or window, such as a web page 702. As shown on the web page 702, the search results include the identified search result 704, which is for Home Depot®. The identified search result 704 is shown with the inclusion of an additional sponsored advertisement in the modified search result 706. In other words, the modified search result 706 replaces the identified search result 704 upon the association of the identified search result 704 with a particular advertisement. The identified search result 704 is identified to be associated with a particular advertisement, as discussed below.

As shown in FIG. 7, the modified search result 706 replaces the identified search result 704. The identified search result 704 may be the displayed result, as displayed without an associated advertisement. The modified search result 706 is one embodiment showing the display of an advertisement associated with the identified search result 704.

In one embodiment, whenever a link to Home Depot® or homedepot.com appears in the search results, then an advertiser may include an additional sponsored listing 708. As shown, Orchard Supply Hardware® and Ace Hardware® provide a sponsored listing 708, which is displayed whenever Home Depot® appears as a search result. In an alternative embodiment, the sponsored listings 708 may appear as a sponsored advertisement in the sponsored advertisement section 710.

Referring back to FIG. 3, bids for each search result are gathered in block 304. The advertisers may purchase an association with a search result. Purchase may refer to a fixed fee or a bidding process based on a price per click, price per impression, or price per conversion. In alternative embodiments, the association with a search result by an advertiser may be obtained through any payment structure, with fixed fee and biding being merely two examples.

In block 306, the advertiser or advertisers with the highest quality bid or highest quality offer are determined. The highest quality bid may be the highest bid, or a combination of the highest bid and a quality score. Alternatively, the highest quality bid may also be a function of more parameters. To simplify the discussion without departing from the spirit or scope of the claims as set forth herein, the highest quality bid may refer to the highest bid. As discussed above regarding FIG. 7, Orchard Supply Hardware® and Ace Hardware® may have had the two highest bids for the search result of Home Depot®. In block 308, a determination is made as to whether the selected search result has appeared as a search result displayed to a user. If not, then the advertisement is not displayed and will not be displayed until the selected search result appears as in block 310. It is also possible that the waiting in block 310 may continue until cancelled. If the selected search result does appear, then the advertisement from the advertiser(s) with the highest bids or offers is displayed as in block 312.

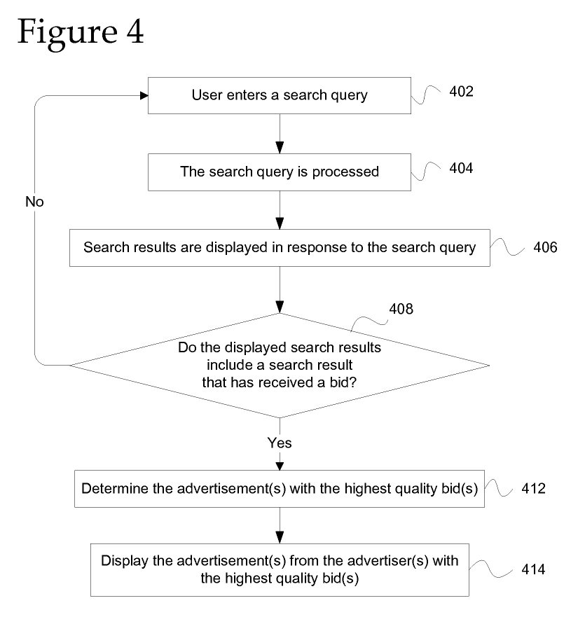

FIG. 4 is a flowchart depicting another embodiment of online advertising according to the present invention. FIG. 4 relates to the processing of a search query and the displaying of search results including an advertisement associated with one of the search results. In block 402, a user enters a search query. As described above, the search query may be transmitted on a web page over a network to a search engine 202. In block 404, the search query is processed. The search engine 202 may process the query to determine those search results that are most relevant to the search query. In block 406, search results are displayed to the user who entered the query. In block 408, if the displayed search results do not include any search results associated with an advertisement, then the system waits for the next search query. Conversely, if at least one of the search results is associated with an advertisement, then the advertisement with the highest bid or offer is determined as in block 412 and those advertisements are displayed as in block 414.

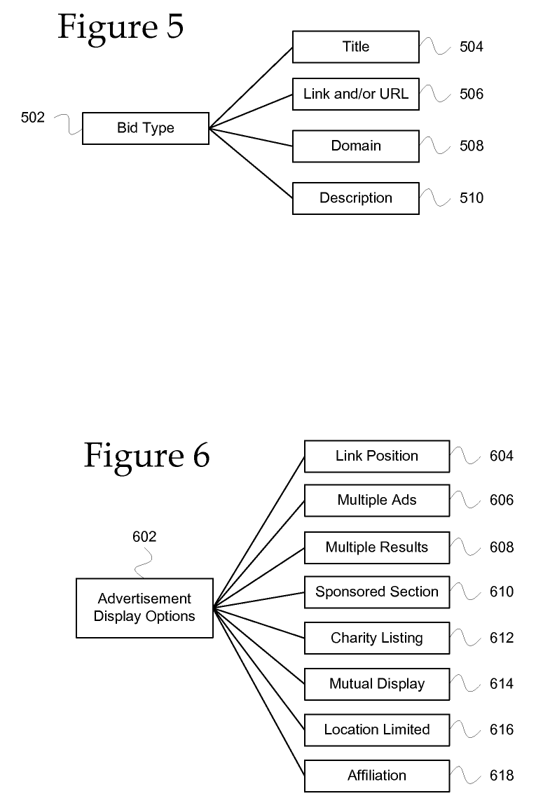

FIG. 5 is a diagram of an embodiment for bidding options. As described, advertisements may be displayed based on the bidding or purchasing of search results. An advertiser may bid for anything that appears on the search result page, including the search results. For example, the bid may be for the title, link, domain, description, words, sponsored results, etc. In addition, it is also possible to combine the bidding for outputs (search results) with the bids for inputs (search queries). Specifically, the advertiser may bid for a search result and a keyword together, and may want to display its advertisement when both occur.

FIG. 5 illustrates bid types 502, which may be various features of a search result that an advertiser may bid on or purchase for associating an advertisement with the search result. For example, a search result may be purchased or bid on based on the title 504 of a search result. The title may be the name of a search result, and for a website the title may refer to the owner of the website or to the content of the website. The search results may each include a title identifying the results, and the name of the title may be purchased for associating with an advertisement. The title of a search result may include any number of words or phrases, any of which may be purchased. For example, in FIG. 7, an advertiser may associate an advertisement with any search result whose title includes Home Depot®.

The link or universal resource locator (URL) 506 of a search result may be associated with an advertisement. An advertiser may associate its advertisement with a particular URL, and when the particular URL is displayed as a search result, the advertisement is also displayed. For example, as in FIG. 7, when the link to www.homedepot.com is included in a search result, an advertisement may displayed. Likewise, an entire domain 508 may be purchased. If the search results include multiple links or URL's from a single domain, then the purchase of a particular domain 508 may create associations for any of those links.

The description 510 included in a search result may also be used for associating a particular advertisement with the description 510. For example, in a search result listing, an advertiser may wish to display its advertisement whenever the phrase “home improvement” appears in a description of any search result. In another example, an advertiser like Ace Hardware® may wish to display its advertisement whenever the phrase “home improvement” and Home Depot® appear together in the same search result or in different search results. Likewise, there may be additional bid types 502 depending on the nature of the search results that may be used for selling advertising. In particular, search results for media other than web pages may have different types of information, which may be used for associating with advertisements.

FIG. 6 is a diagram of one embodiment of different options for displaying advertisements. In particular, FIG. 6 illustrates advertisement display options 602 that may represent different types of advertisements, advertising scenarios, and/or display restrictions. As described below, the advertisement display options 602 may include different examples, scenarios, or locations for the advertisements that are associated with search results.

One option for displaying advertisements may include the link position 604. The link position 604 refers to the order within the search results that a particular link is displayed. The link position 604 may also be referred to as a ranking. In one example, the advertisement may only be displayed if the associated search result appears in the first three results. Alternatively, if an advertisement is bid or paid for such that it could appear on multiple search results that are shown in response to a search query, then the advertisement may be displayed with just one of the results or may be displayed as associated with multiple search results. In an alternative embodiment, the link position 604 may also allow an advertiser to limit a potentially undesirable search result. For example, if the search result that an advertisement is associated with does not appear in the first ten results, then the advertisement may not be displayed.

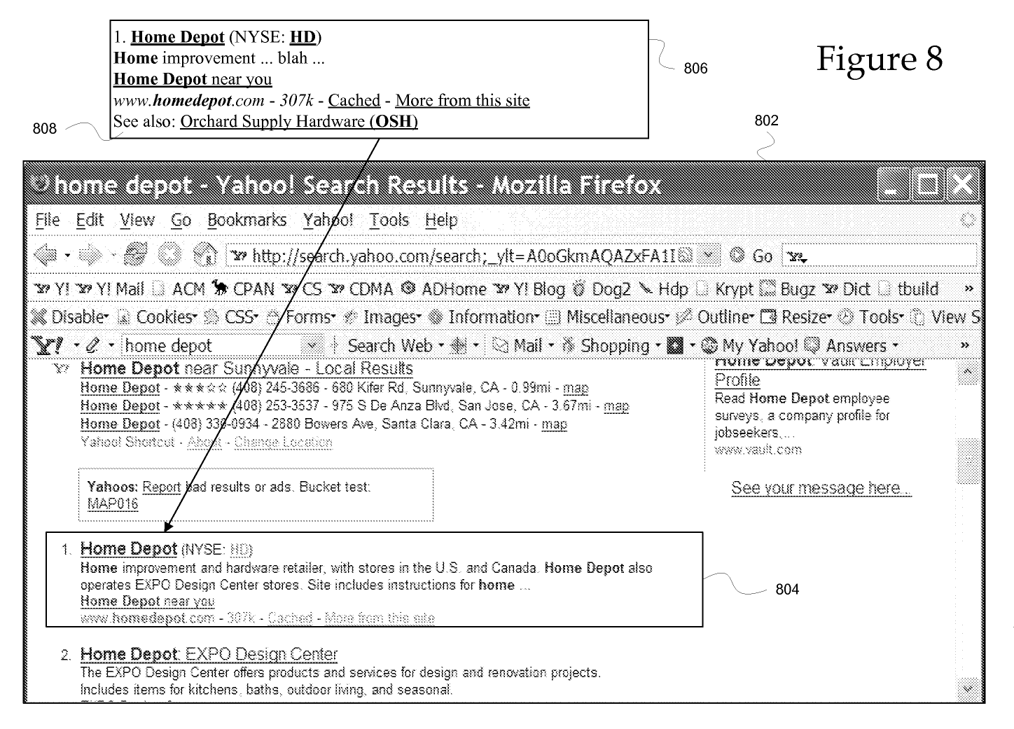

FIG. 8 is an illustration of one embodiment of search results with an advertisement displayed based on the link position 604. In particular, web page 802 shows a first search result 804 for Home Depot®. Likewise, the second search result is also for a Home Depot® link. The modified search result 806 replaces the identified search result 804. The identified search result 804 may be the displayed result, as displayed without an associated advertisement and the modified search result 806 is one embodiment showing the display of an advertisement associated with the identified search result 804. As shown in the modified search result 806, a sponsored advertisement 808 for Orchard Supply Hardware® is included. Orchard Supply Hardware® may have bid for any search result related to Home Depot®; however, if there are multiple search results related to Home Depot® then the advertisement 808 is only included with the highest ranking search result 804.

Another advertisement display option 602 may include multiple ads 606. Multiple ads 606 may refer to the display of multiple advertisements that are associated with a particular search result. In other words, one search result may have multiple advertisements that are associated with that result. In one embodiment, each search result may be allowed a certain number of advertisements to be associated with that result. The advertisements displayed may be those with the highest bid or price offered for the advertisements, but limited based on the certain number of advertisements that are allowed per search result. The advertisements for a particular search result that are displayed may be further ordered based on the bid or offer price for the advertisement. Those advertisements with higher bids or offers may receive the superior location for display.

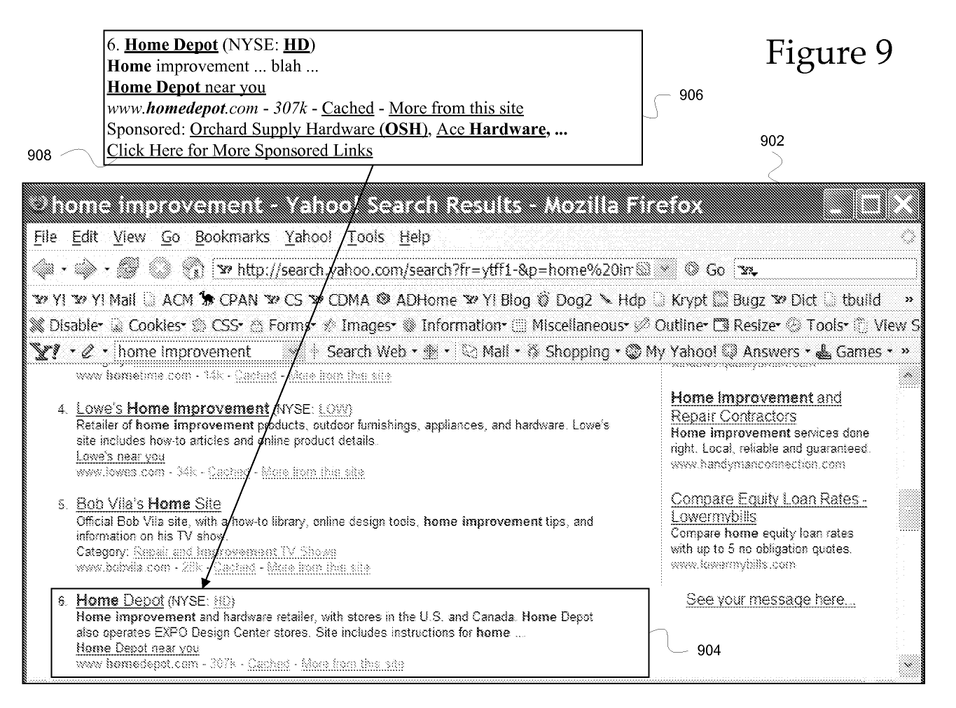

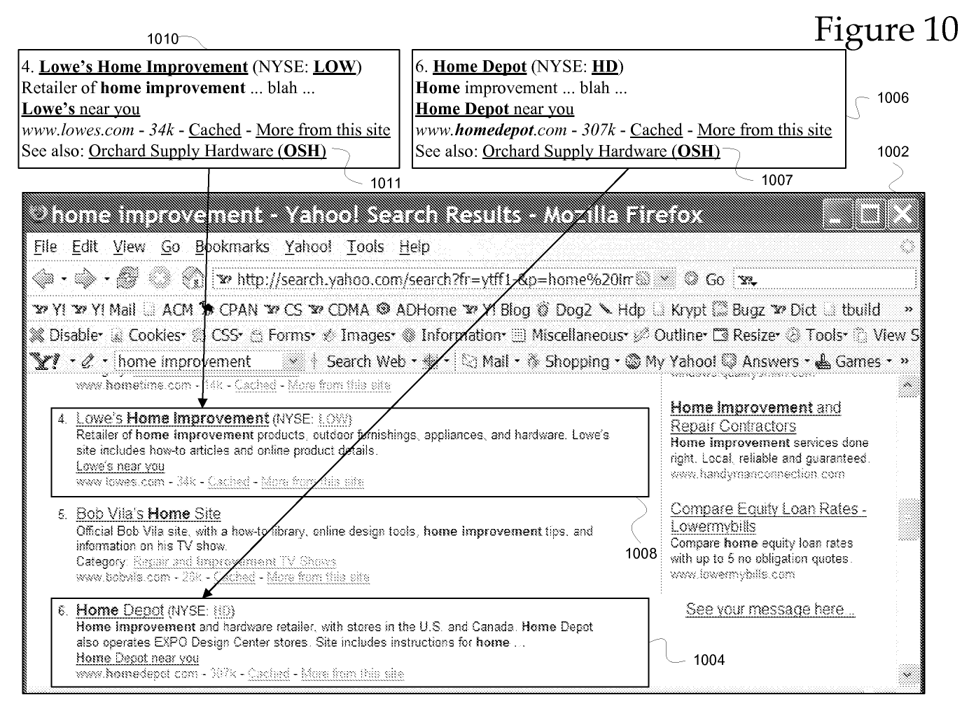

FIG. 9 is an illustration of one embodiment of search results with an advertisement displayed with multiple advertisements. In particular, web page 902 includes a search result 904 for which multiple advertisers have bid for associating advertisements with that search result 904. The modified search result 906 may replace the search result 904. The search result 904 does not include an advertisement and the modified search result 906 is one embodiment showing the display of an advertisement associated with the search result 904. In particular, the modified search result 906 shows two sponsored advertisements. Both of Orchard Supply Hardware® and Ace Hardware® have bid on the search result 904 Home Depot®. They are the two highest bidders and are displayed first. In one embodiment, there may be a link 908 which a user can click on or hover over to see a listing of additional advertisements and/or advertisers who have also purchased an association with the search result 904. In an alternative embodiment, all of the sponsored advertisements may be shown, or there may be a limit to the number of advertisements that are shown with or without a link 908 which shows additional advertisements associated with the search result 904.

Another advertisement display option 602 is the association of an advertisement with multiple results 608. An advertiser may associate its advertisement with a plurality of search results. Accordingly, that advertisement may be displayed with multiple search results when those search results are displayed. In one embodiment, the advertisement may be limited to a certain number of appearances on a single search result page. In other words, if an advertisement is associated with two search results and both search results are displayed, the advertisement may only be displayed once with one of the search results. Conversely, once an association has been made that is determined to be the most relevant (highest bid/offer), then the advertisement may be displayed for each search result it is associated with. The advertiser may purchase multiple search results, and subsequently limit the display of an advertisement based on the display of those search results.

FIG. 10 is an illustration of one embodiment of search results with an advertisement displayed with multiple results. In particular, web page 1002 includes a first search result 1004 and a second search result 1008, both of which may be associated with a single advertisement. The modified search results 1006 and 1010 may replace the search result 1004 and 1008, respectively. The search results 1004, 1008 do not include an advertisement and the modified search results 1006, 1010 are one embodiment showing the display of an advertisement associated with the search results 1004, 1008, respectively. In particular, the first modified search result 1006 includes a sponsored advertisement 1007 for Orchard Supply Hardware®. Likewise, the second modified search result 1010 also includes a sponsored advertisement 1011 for Orchard Supply Hardware®. As shown in web page 1002, Orchard Supply Hardware® purchased advertisements for a search result of Lowe's® and a search result of Home Depot®, both of which appear on the page. The modified search results 1006, 1010 show the sponsored advertisement for both of the search results. In an alternative embodiment, if an advertisement is associated with multiple displayed search results, then the search result that is ranked the highest may be the only result for which the advertisement is displayed. Accordingly, the multiple results option 608 may include the purchase of multiple results regardless of how frequently an associated advertisement is displayed.

In one embodiment, the advertisement may be displayed only if the advertiser or advertisement is not one of the search results. For example, for the search query “home improvement” shown in web page 1002, Orchard Supply Hardware® may have been one of the search results. In such a case, Orchard Supply Hardware® may not want its sponsored advertisements to appear with other search results because it was a search result of the search query. Alternatively, an advertiser may purchase a combination of search results, such that the advertisement only appears if the combination of search results appears.

Another advertisement display option 602 may be for a sponsored section 610. The sponsored section 610 may be one example of a different location in which an advertisement may be displayed. For example, rather than displaying the advertisement adjacent to the associated search result (as in advertisements 1007 and 1011 in FIG. 10), the advertisement may be displayed at a different location. One embodiment may include displaying the advertisement in the sponsored advertisement section of a web page.

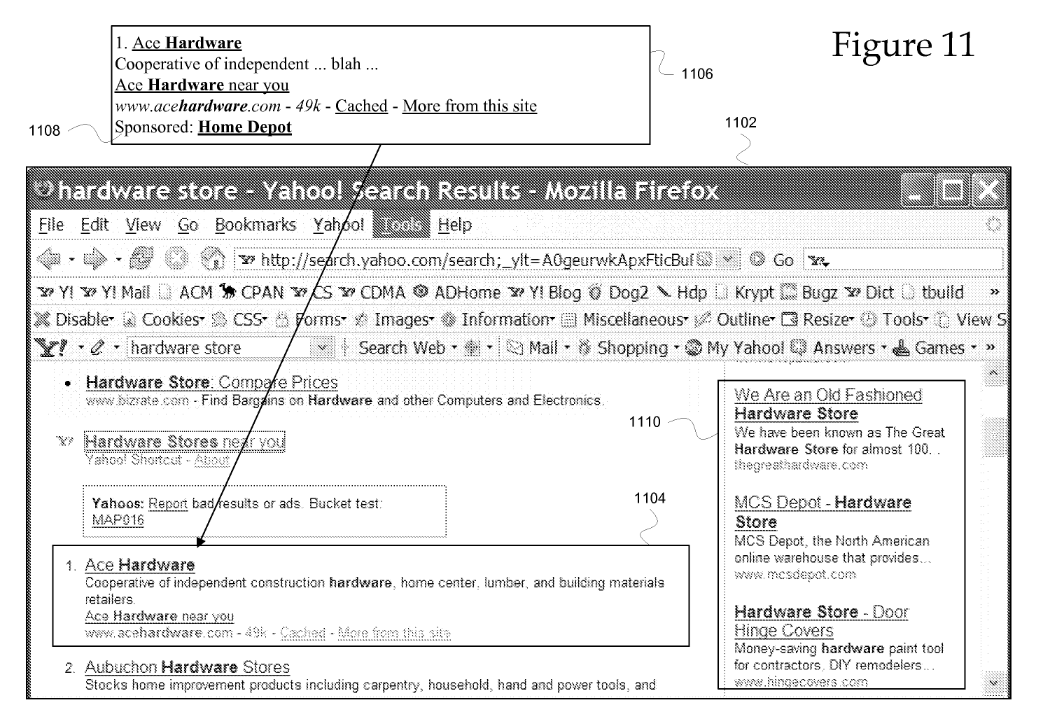

FIG. 11 is an illustration of one embodiment of search results with an advertisement, which may include a sponsored section 610. In particular, web page 1102 displays a sponsored section 1110 of advertisements. The sponsored section 1110 may include advertisements that are displayed separately, so that the user knows it is a listing of advertisements rather than search results. In one embodiment, the sponsored advertisement 1108 may not be displayed in the modified search result 1106, rather it may appear in the sponsored section 1110. The location of the sponsored advertisement 1108 may be confusing to a user if the search engine wishes to more clearly delineate what is a search result 1104 and what is an advertisement. The modified search result 1106 may replace the search result 1104. The search result 1104 does not include an advertisement and the modified search result 1106 is one embodiment showing the display of an advertisement associated with the search result 1104.

In an alternative embodiment, the sponsored section 610 may include multiple sections for types of advertisements. For example, the advertisements derived from the input may be separated from the advertisements related to the output. Alternatively, the sponsored section 610 may include all advertisements from either output or input and be ordered based on relevance or based on price or bid.

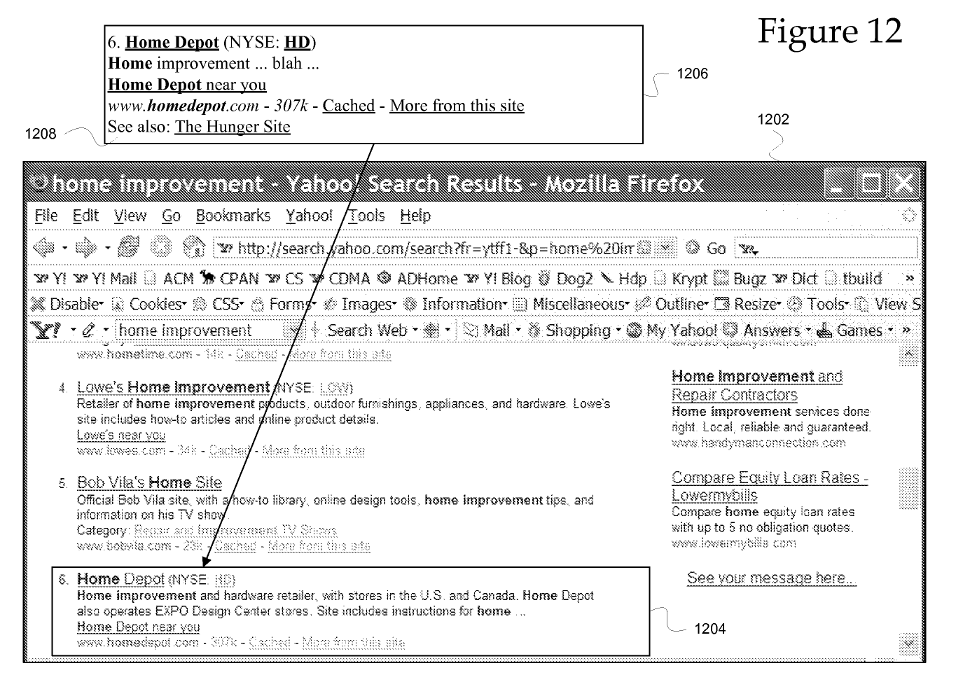

Another advertisement display option 602 may be a charity listing 612. In one embodiment, an advertiser may advertise a charity whenever it appears as a search result. FIG. 12 is an illustration of one embodiment of search results with an advertisement displayed that is a charity listing 612. In particular, web page 1202 includes a search result 1204 that is of an advertiser. The modified search result 1206 may replace the search result 1204. The search result 1204 does not include an advertisement or charity listing, and the modified search result 1206 is one embodiment showing the display of a charity listing associated with the search result 1204. Home Depot® may wish to purchase its search result, and display a charitable organization anytime it appears as a search result. In particular, the modified search result 1206 shows a charity listing 1208 for The Hunger Site. Accordingly, any time a search result for Home Depot® appears, The Hunger Site is also advertised. In one embodiment, the identity of the search result may be the purchaser of the advertisement space for the charity listing, or the charity itself or a third party may purchase the advertisement for display with the search result 1204.

Another advertisement display option 602 may be for a mutual display 614. In one embodiment, an advertisement for entity X may be associated with entity Y, and an advertisement for entity Y may be associated with entity X. This mutual display 614 may be beneficial for both entity Y and entity X when either entity is unsure of the search results that may be displayed. Both entities may increase their exposure. For example, Home Depot® and Ace Hardware® may agree to a mutual display in the sense that they may cover the cost of bidding together so that the search engine displays Home Depot® whenever it displays Ace Hardware® or vice versa.

Another advertisement display option 602 may be limiting the location 616 of an advertisement. In one embodiment, an advertisement may only be displayed for certain locations of a user device. The search engine may identify the location of the user and the advertisement may only be relevant to users in a certain location, so it is only displayed when the user's location is identified as being in the certain location. IP address, user log-in, search keywords, web browsing may be used to identify the location of a user. In one embodiment, if a user is not located the advertisement may not be displayed.

Another advertisement display option 602 may be for an affiliation 618. In one embodiment, an advertiser may bid for itself, or at least one of its affiliated entities such as other related companies, organizations, causes, promotions, hiring, news, etc. For example, Home Depot® may bid for itself in the sense that when it appears in the search results, it wants an advertisement to one or more of its affiliated entities to be displayed. One such entity may be an affiliated company that they want to promote. Another such entity may be a certain brand of products that they are offering as a promotion. Restricting the display of an entity such as a promotion to a time frame, location, input query, user characteristics, search patterns, or to other options may be possible to improve the quality of advertisements.

A bid for an advertisement associated with an output may be combined with other forms of advertising. The bid for an output from a search engine may also be limited by the input of the search keyword. An advertiser may purchase a search result, but only have the advertisement displayed for certain search queries. For example, a hardwood flooring advertiser may purchase Home Depot® as a search result combined with a search keyword that includes the word “hardwood floor.” This limitation may improve the relevancy of the advertisement based on both the input and the output of the search query.

An entity that appears in a search result page may bid for disallowing bids from entities it is not affiliated with or not promoting. For example, Home Depot® may bid on itself to disallow any of its competitors to bid for the display of its link or name in the search results. A search engine operator may exclude such disallowing bids as a bid type, or it may collaborate with such entities, in financial deals or otherwise, to define bidding and display options.

Referring to FIG. 13, an illustrative embodiment of a general computer system is shown and is designated 1300. The computer system 1300 can include a set of instructions that can be executed to cause the computer system 1300 to perform any one or more of the methods or computer based functions disclosed herein. The computer system 1300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1300 can be implemented using electronic devices that provide voice, video or data communication. Further, while a single computer system 1300 is illustrated, the term “system” shall also be taken to include any collection of systems or sub-systems that individually or jointly execute a set, or multiple sets, of instructions to perform one or more computer functions.

As illustrated in FIG. 13, the computer system 1300 may include a processor 1302, e.g., a central processing unit (CPU), a graphics processing unit (GPU), or both. The processor 1302 may be a component in a variety of systems. For example, the processor 1302 may be part of a standard personal computer or a workstation. The processor 1302 may be one or more general processors, digital signal processors, application specific integrated circuits, field programmable gate arrays, servers, networks, digital circuits, analog circuits, combinations thereof, or other now known or later developed devices for analyzing and processing data. The processor 1302 may implement a software program, such as code generated manually (i.e., programmed).

The computer system 1300 may include a memory 1304 that can communicate via a bus 1308. The memory 1304 may be a main memory, a static memory, or a dynamic memory. The memory 1304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 1304 includes a cache or random access memory for the processor 1302. In alternative embodiments, the memory 1304 is separate from the processor 1302, such as a cache memory of a processor, the system memory, or other memory. The memory 1304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1304 is operable to store instructions executable by the processor 1302. The functions, acts or tasks illustrated in the figures or described herein may be performed by the programmed processor 1302 executing the instructions stored in the memory 1304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1300 may further include a display unit 1314, such as a liquid crystal display (LCD), an organic light emitting diode (OLED), a flat panel display, a solid state display, a cathode ray tube (CRT), a projector, a printer or other now known or later developed display device for outputting determined information. The display 1314 may act as an interface for the user to see the functioning of the processor 1302, or specifically as an interface with the software stored in the memory 1304 or in the drive unit 1306.

Additionally, the computer system 1300 may include an input device 1316 configured to allow a user to interact with any of the components of system 1300. The input device 1316 may be a number pad, a keyboard, or a cursor control device, such as a mouse, or a joystick, touch screen display, remote control or any other device operative to interact with the system 1300.

In a particular embodiment, as depicted in FIG. 13, the computer system 1300 may also include a disk or optical drive unit 1306. The disk drive unit 1306 may include a computer-readable medium 1310 in which one or more sets of instructions 1312, e.g. software, can be embedded. Further, the instructions 1312 may embody one or more of the methods or logic as described herein. In a particular embodiment, the instructions 1312 may reside completely, or at least partially, within the memory 1304 and/or within the processor 1302 during execution by the computer system 1300. The memory 1304 and the processor 1302 also may include computer-readable media as discussed above.

The present disclosure contemplates a computer-readable medium that includes instructions 1312 or receives and executes instructions 1312 responsive to a propagated signal, so that a device connected to a network 1320 can communicate voice, video, audio, images or any other data over the network 1320. Further, the instructions 1312 may be transmitted or received over the network 1320 via a communication port 1318. The communication port 1318 may be a part of the processor 1302 or may be a separate component. The communication port 1318 may be created in software or may be a physical connection in hardware. The communication port 1318 is configured to connect with a network 1320, external media, the display 1314, or any other components in system 1300, or combinations thereof. The connection with the network 1320 may be a physical connection, such as a wired Ethernet connection or may be established wirelessly as discussed below. Likewise, the additional connections with other components of the system 1300 may be physical connections or may be established wirelessly.

The network 1320 may include wired networks, wireless networks, or combinations thereof. The wireless network may be a cellular telephone network, an 802.11, 802.16, 802.20, or WiMax network. Further, the network 1320 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for displaying an advertisement on a page, the method comprising:
receiving a search query;
providing at least one search result on the page, wherein the at least one search result is based on the search query;
associating the advertisement with an associated search result; and
displaying the advertisement on the page when the associated search result is one of the at least one search result on the page.

2. The method according to claim 1 wherein the page is a web page.

3. The method according to claim 2 wherein the at least one search result on the page includes a link to a web site associated with the search result.

4. The method according to claim 1 wherein the act of associating the advertisement with at least one of the at least one search result comprises:
receiving a bid of the advertisement from at least one advertiser for one of the at least one search results; and
receiving instructions for displaying the advertisement, wherein the instructions include an identification of the one of the at least one search result associated with the advertisement.

5. The method according to claim 4 wherein the act of displaying the advertisement with the associated search result further comprises:
comparing the bid of the advertisement from the at least one advertiser with other bids for the associated search result; and
displaying the advertisement when the bid of the advertisement from the at least one advertiser is a highest quality bid.

6. The method according to claim 4 wherein the one of the at least one search result is related to a competitor of the at least one advertiser.

7. The method according to claim 4 wherein the one of the at least one search result is related to an affiliate of the at least one advertiser.

8. The method according to claim 1 wherein the advertisement is displayed adjacent the associated one of the at least one search result.

9. The method according to claim 1 wherein the advertisement is displayed in a sponsored advertisement location.

10. A method for displaying information associated with a search result on a page, the method comprising:
receiving the information associated with the search result;
receiving a search query;
displaying one or more search results on the page in response to receiving the search query; and
displaying the information associated with the search result when the associated search result is one of the search results that are displayed on the page, wherein the information associated with the associated search result is not displayed when the associated search result is not one of the search results.

11. The method according to claim 10 wherein the information is an advertisement.

12. The method according to claim 10 wherein the page is a web page and the search results include links to web pages, further wherein the associated search result includes a link to a web site.

13. (canceled)

14. The method according to claim 10 wherein the information is selected by an information provider for display adjacent the associated search result.

15. The method according to claim 10 wherein the association of the information with the search result on a page comprises:
receiving a bid for the information from an information provider for one of the search results; and
receiving instructions for displaying the information, wherein the instructions include identification of the associated search result that is associated with the information.

16. In a computer readable storage medium having stored therein data representing instructions executable by a programmed processor for displaying an advertisement associated with an output, the storage medium comprising instructions operative for:
receiving a search query;
providing one or more outputs in response to the search query;
comparing the output associated with the advertisement with the outputs; and
displaying the advertisement when the output associated with the advertisement is one of the outputs, wherein the advertisement is displayed with the outputs.

17. The storage medium according to claim 16 wherein the output comprises at least one search result.

18. The storage medium according to claim 16 wherein the output associated with the advertisement is purchased by an advertiser, such that the advertisement is displayed when the output associated with the advertisement is one of the outputs.

19. The storage medium according to claim 18 wherein the purchase is based on a bid, such that the purchase is the highest quality bid for the output associated with the advertisement.

20. A system displaying an advertisement, the system comprising:
a network;
a search engine coupled with the network and configured to receive a search query over the network and provide search results; and
an ad server coupled with the search engine and configured to provide the advertisement to the search engine for display with the search results when the advertisement is associated with a selected search result and the selected search result is one of the search results.

21. The system according to claim 20 wherein the advertisement is associated with the selected search result when an advertiser purchases the selected search result, so that the advertisement is displayed when the selected search result is one of the search results displayed in response to the search query.

22. The system according to claim 21 wherein the purchase of the selected search result is based on a bidding process for the selected search result, such that the purchase of the selected search result is the highest quality bid.

23. The system according to claim 20 further comprising a user device coupled with the search engine over the network, wherein the user device is configured to provide the search query to the search engine and configured to received the search results.

24. The system according to claim 23 wherein the user device is connected with the search engine over the Internet.

25. The system according to claim 24 wherein the user device includes a web browser configured to display web pages, wherein the search query is provided on a search web page and the search results are displayed on a search results web page.

26. The system according to claim 25 wherein the search results are web links and the advertisement is displayed with the web link for the selected search result.
